(19) United States
(12) Patent Application Publication
(10) Pub. No.: US 2015/0377724 A1
(43) Pub. Date: Dec. 31, 2015

(54) TORQUE MEASURING DEVICE

(71) Applicant: Schaeffler Technologies AG & Co. KG, Herzogenaurach (DE)

(72) Inventors: Frank Benkert, Waigolshausen (DE); Jens Heim, Bergrheinfeld (DE); Matthias Sperber, Wachenroth (DE); Jurgen Gierl, Erlangen (DE); Christian Nuissl, Furth (DE); Stefan Gluck, Schweinfurt (DE)

(73) Assignee: Schaeffler Technologies AG & Co. KG, Herzogenaurach (DE)

(21) Appl. No.: 14/768,070

(22) PCT Filed: Dec. 10, 2013
(86) PCT No.: PCT/DE2013/200342

§ 371 Date: Aug. 14, 2015

(30) Foreign Application Priority Data
Feb. 14, 2013 (DE) 10 2013 202 383.9

(51) Int. Cl. G01L 3/10; G01L 5/22

(52) U.S. Cl. CPC G01L 3/105; G01L 5/225

(57) ABSTRACT

A torque measuring device, in particular suitable for a bottom bracket (1), including an inner shaft (2) provided as a drive shaft, and a hollow shaft (3) provided as a driven shaft, which hollow shaft is connected to the inner shaft (2) and surrounds the same coaxially. The hollow shaft (3) has a direct coating that forms a strain gauge (5) for the torque measurement.

### FIELD OF THE INVENTION

The invention relates to a torque measuring device and to a bottom bracket that is equipped with a torque measurement device. The invention also relates to a method for producing a torque measurement device.

### BACKGROUND

A torque measurement device that measures torque acting in a shaft typically detects a twisting of the shaft that is dependent on the torque to be measured. The twisting can be detected, for example, optically. A torque measurement with optical methods is known, in principle, from DE 10 2005 055 949 A1.

For detecting an angular position of a shaft or a twisting between two components that can be torqued relative to each other, magnetic solid measures are also suitable. In this context, for example, DE 10 2010 023 355 A1 is to be named as prior art.

Likewise it is possible to measure torque acting in a shaft or sleeve via the torque-dependent change in magnetic properties at least of a magnetic section of the shaft or the sleeve. A measurement device based on this design is known, for example, from EP 2 365 927 A1, which relates to a bottom bracket.

For the torque measurement, in principle, also strain gauges are suitable that are applied to a suitable position of a component loaded by a torque. German Patent Application 10 2012 208 492.4 discloses a method for producing a strain gauge arrangement in which a deformation-sensitive measurement layer is deposited on the surface of a shaft and is then processed by means of a laser.

### SUMMARY

The use of strain gauges for vehicle wheels with electric auxiliary drive is described, for example, in CN201737127U. A strain gauge is located in this case on a torsion sleeve.

The invention is based on the objective of improving a torque measurement device, in particular, with respect to the reliable reproducibility of product properties in large-scale production compared with the stated prior art.

This objective is achieved by a torque measurement device, by a bottom bracket, and by a method including one or more features of the invention. Below, constructions and advantages of the invention explained in connection with the torque measurement device or the bottom bracket apply analogously also to the production method and vice versa.

A torque measurement device comprises
an inner shaft provided as a drive shaft,
a hollow shaft provided as a driven shaft and connected to the inner shaft and coaxially surrounding this inner shaft,

wherein the hollow shaft has a direct coating comprising a strain gauge for the torque measurement.

A direct coating is here understood to be a coating that is generated directly on a component to be coated during its production process. A typical, general example of this is the painting of a component: the paint layer is first generated directly on the component to be painted during the painting process. A counter-example that does not fall under the definition of a direct coating is the bonding of a film on a component.

Direct coating, which forms, overall, a strain gauge or has properties that are at least partially sensitive to deformation, can be generated according to DE Patent Application 10 2012 208 492.4.

The hollow shaft on which the strain gauge is generated in the form of a direct coating is advantageously produced from a metallic base material, in particular, steel, wherein an insulation layer is deposited on the base material on which a deformation-sensitive layer is located as a measurement layer. In comparison with a strain gauge bonded on a twistable part, the construction of the torque measurement device according to the invention is distinguished by much better reproducibility and long-term stability of the measurement properties. Another advantage is given in that neither the hollow shaft nor the inner shaft is weakened by structures such as notches or grooves.

The insulation layer on which the deformation-sensitive layer provided for the torque measurement is deposited comprises, for example, an oxide or a carbide. Suitable materials for the insulation layer are, in particular, Al₂O₃ and SiO2. Likewise, an amorphous carbon layer is suitable as the insulation layer. The insulation layer can be produced, for example, using PVD (physical vapor deposition) or PACVD (physical assisted chemical vapor deposition) methods. The use of polymers for producing the insulation layer is also possible.

The measurement layer that is located on the insulation layer is formed, for example, by a nickel alloy, in particular, a NiCr alloy, and advantageously has a thickness of 0.05 μm to 1.0 μm.

In a preferred construction, an organic or inorganic protective layer is deposited on the measurement layer. The total thickness of the deformation-sensitive direct coating, including the protective layer, is advantageously not greater than 20 μm.

In addition to the direct coating acting as a strain gauge, a signal transmission component that interacts with another stationary signal transmission component is located on the hollow shaft according to one advantageous improvement. In a simple construction, the signal transmission component can be a slip ring. As an alternative, a wireless, for example, inductive signal transmission between the hollow shaft and a non-rotating component is provided. In addition to the signal transmission, in both cases, a wired or wireless energy transmission is possible between the hollow shaft equipped with the torque sensors and a surrounding, non-rotating component. The contact-free signal and energy transmission has, compared with the simpler solution operating with slip contacts, the principle advantage of no wear and lower susceptibility to contaminating particles. In addition, the non-contact transmission of signals and energy produces an advantage with respect to the braking moment generated by the rotation of the unit made from the inner shaft and hollow shaft.

In addition to a signal transmission component, the hollow shaft optionally also has a signal evaluation component. The energy required for the operation of this signal evaluation component can also be transmitted either via a touching contact or non-contact method. In embodiments in which there is no signal evaluation component on the hollow shaft or a part connected to this hollow shaft, the signal processing can take place, for example, in a housing of the torque measurement device or in an external evaluation unit outside of the housing.

Independent of how any signal evaluation component is formed on the rotating hollow shaft or on a part locked in rotation with this hollow shaft, a component of a rotational speed measurement device can be arranged on the inner shaft or on a part locked in rotation with this inner shaft.

The torque measurement device according to the invention is especially suitable for use in a bicycle with an electric auxiliary drive. In general, the torque measurement device is suitable for all applications in which a torque can be introduced into a drive shaft at two different points and the total introduced torque is forwarded by means of a single driven shaft concentrically surrounding the drive shaft. The torque measurement device reliably detects, in such a case, the total torque acting in the driven shaft.

The method for producing the torque measurement device comprises, independent of the technical field of application, the following features:
a) A coating providing a measurement layer for torque measurement and forming a strain gauge is deposited as a direct coating on a base material of a hollow shaft, wherein the strain gauge is structured only after depositing the coating on the hollow shaft,
b) The hollow shaft is locked in rotation with an inner shaft arranged coaxially within this hollow shaft, wherein the inner shaft forms a drive shaft and the hollow shaft forms a driven shaft.

The strain gauge can here either be generated on the hollow shaft provided as a single part or can be deposited only after the final assembly of the module comprising the hollow shaft and the inner shaft. The processing step a) can be executed before or after the processing step b). Likewise it is possible to deposit a direct coating acting as a strain gauge as an arbitrary intermediate step during the production of the torque measurement device.

The coating having deformation-sensitive properties and forming a strain gauge can be produced using a PVD or PACVD method. This coating is structured preferably by laser, as described in DE Patent Application 10 2012 208 492.4.

The strain gauge processed by laser has, in an advantageous construction, a strip structure, wherein the individual strips each describe a section of a helical line running about the rotational axis of the hollow shaft, advantageously set at an angle relative to the rotational axis by 30° to 60°, advantageously by 45°. As an alternative to the laser processing of the deformation-sensitive layer, photolithographic processing is also possible. In each case, a layer that is not arranged in a plane, but instead represents a three-dimensional structure, is processed directly. The arrangement of the deformation-sensitive structures on the surface of the hollow shaft takes place advantageously in a full-bridge arrangement. Contact pads can be placed in areas of the surface of the direct coating not used for measuring the torque and produced by the specified 45° meander structure. The contact locations can also be protected from environmental effects just like the other areas of the surface regions formed for torque measurement and optionally for signal processing with a protective layer. Including the total construction and connection technology, as well as energy and signal transmission technology, the overall torque measurement device has an extremely space-saving design. Components of the energy and signal transmission technology that are arranged outside of the torque measurement device are advantageously located in a similar space-saving arrangement in an essentially sleeve-shaped component directly surrounding the torque measurement device.

For the use of the torque measurement device in a bicycle with electric auxiliary drive, all components of the torque and rotational speed sensors can be integrated into the frame within the installation space of the bottom bracket. The torque and rotational speed measurement system can provide a performance measurement system with which the performance of the bicyclist, also for semi-professional bicyclists, can be determined and displayed.

An embodiment of the invention is explained in more detail below with reference to a drawing. Shown herein in partially simplified representation are:

### BRIEF DESCRIPTION OF THE DRAWINGS

FIG. 1 a bottom bracket with a torque measurement device, and

FIG. 2 a detail of the bottom bracket according to FIG. 1.

### DETAILED DESCRIPTION OF THE PREFERRED EMBODIMENTS

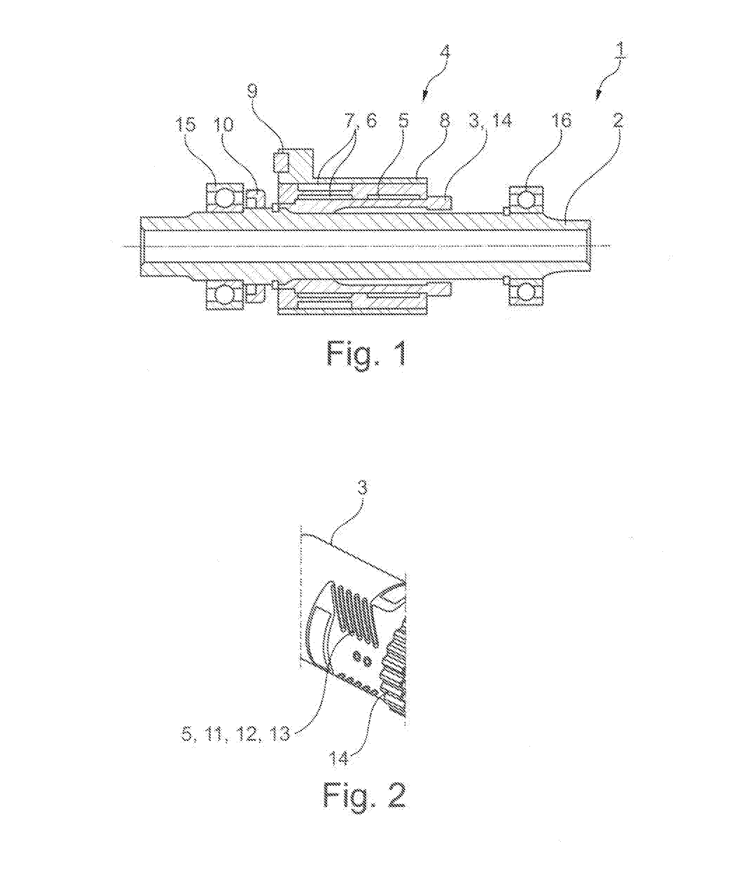

A bottom bracket marked overall with the reference symbol 1 in FIG. 1 has a shaft 2 that is supported by two rolling bearings 15, 16, namely ball bearings, which can rotate in the frame of a bicycle that is not shown in more detail with an electric auxiliary drive. At both ends of the shaft 2 there is a not-shown foot pedal. The shaft 2 is hollow and is also called an inner shaft.

A hollow shaft 3 that concentrically surrounds the shaft 2 is connected rigidly to the inner shaft 2 on one side. In the section of the hollow shaft 3 not connected to the inner shaft 2, this is spaced apart from the shaft 2, so that a ring gap is formed between the inner shaft 2 and the hollow shaft 3.

On the right side of the hollow shaft 3 in the arrangement according to FIG. 1, this is locked in rotation in a not-shown way, directly or indirectly, with a chain ring carrier of the bicycle. With respect to the principle function of the bottom bracket 1, refer to the prior art cited in the introduction, in particular, EP 2 365 927 A1.

In interaction with the inner shaft 2, the hollow shaft 3 acts as a torque measurement device 4 that will also be described below wither reference to FIG. 2:

A strain gauge 5 produced as a direct coating is located on the outer surface of the hollow shaft 3. Because the entire torque introduced into the inner shaft 2 via the foot pedals on both sides of this inner shaft is transmitted via the hollow shaft 3 to the chain ring carrier, the twisting of the hollow shaft 3 indicates exactly the sum of the torque applied by the rider on the inner shaft 2.

In addition to the strain gauge 5, on the hollow shaft 3 there is a first signal and energy transmission component 6. A second signal and energy transmission component 7 interacting with this first component is arranged in an essentially sleeve-shaped sensor housing 8 concentrically surrounding the hollow shaft 3. In the illustrated embodiment, the signal and energy transmission components 6, 7 are used for the inductive energy and signal transmission between the rotating component comprising the inner shaft 2 and the hollow shaft 3 and the sensor housing 8 arranged rigidly in the bicycle frame. On the sensor housing 8, a sensor connection 9 can also be seen. A cable connected to this sensor connection 9 typically runs within a frame tube of the bicycle. A rotational speed measurement component 10 that is mounted on the inner shaft 2 and interacts with another, frame-fixed rotational speed measurement component can also be seen in FIG. 1.

The strain gauge 5 produced as a direct coating on the hollow shaft 3 comprises an insulation layer 11 generated directly on the base material, namely steel, of the hollow shaft 3, a measurement layer 12 that is generated directly on this insulation layer and is structured by laser and forms the actual deformation-sensitive layer, and also a protective layer 13 shielding the measurement layer 12 and contact points from environmental effects.

With regard to the structuring of the strain gauge 5, refer to FIG. 2 in which teeth 14 can also be seen that are used for connecting the chain ring carrier to the hollow shaft 3. The strain gauge 5 is overall on a cylindrical surface, namely the surface of the hollow shaft 3 and is generated during the production of the torque measurement device 4 on this surface. In contrast to the prior art that provides the bonding of a strain gauge originally produced in a plane on a shaft or another curved component, according to the invention, a three-dimensional deformation-sensitive structure is generated, namely the strain gauge 5 formed as a direct coating. This generation includes the deposition of the deformation-sensitive layer by a PVD or PACVD method, as well as the subsequent laser structuring of the layer.

### LIST OF REFERENCE NUMBERS

1 Bottom bracket
2 Inner shaft
3 Hollow shaft
4 Torque measurement device
5 Strain gauge
6 First signal and energy transmission component
7 Second signal and energy transmission component
8 Sensor housing
9 Sensor connection
10 Rotational speed measurement component
11 Insulation layer
12 Measurement layer
13 Protective layer
14 Teeth
15 Rolling bearing
16 Rolling bearing

1. A torque measurement device (4), comprising:
an inner shaft provided as a drive shaft,
a hollow shaft connected to the inner shaft and provided as a driven shaft coaxially surrounding said inner shaft,
wherein the hollow shaft has a direct coating comprising a strain gauge for torque measurement, the strain gauge has a measurement layer, the strain gauge is arranged directly on a cylindrical surface of the hollow shaft, and the measurement layer has laser structuring.

2. The torque measurement device according to claim 1, wherein the hollow shaft has a metallic base material, an insulation layer deposited on the base material, and the measurement layer is deposited on said insulation layer and forms the strain gauge.

3.-6. (canceled)

7. The torque measurement device according to claim 1, wherein the measurement layer is at least 0.05 μm and at most 1.0 μm thick.

8. The torque measurement device according to claim 1, wherein the measurement layer is formed from an NiCr alloy.

9. The torque measurement device according to claim 1, wherein a protective layer is deposited on the measurement layer.

10. The torque measurement device according to claim 1, wherein a total maximum thickness of the direct coating is 20 μm.

11. The torque measurement device according to claim 1, further comprising a signal transmission component arranged on the hollow shaft.

12. The torque measurement device according to claim 11, wherein a slip ring is provided as the signal transmission component.

13. The torque measurement device according to claim 11, wherein the signal transmission component is formed for wireless signal transmission.

14. The torque measurement device according to claim 1, further comprising a signal evaluation component arranged on the hollow shaft.

15. The torque measurement device according to claim 1, further comprising a rotational speed measurement component arranged on the inner shaft.

16. A bottom bracket, comprising a torque measurement device according to claim 1.

17. A method for the production of a torque measurement device with the following features:
depositing a coating that provides a measurement layer for torque measurement and for forming a strain gauge as a direct coating on a base material of a hollow shaft, structuring the strain gauge only after the coating is deposited on the hollow shaft,
locking the hollow shaft in rotation with an inner shaft arranged coaxially within said hollow shaft, wherein the inner shaft forms a drive shaft and the hollow shaft forms a driven shaft, and the strain gauge is deposited directly on a cylindrical surface of the hollow shaft, and the strain gauge is structured by laser processing.

18.-19. (canceled)

20. The method according to claim 17, wherein, for producing the direct coating, first an insulation layer is generated on the base material of the hollow shaft and then the measurement layer is generated on the insulation layer.

21. The method according to claim 20, wherein at least one of the insulation layer and measurement layer is generated with a PVD or PACVD method.

22. (canceled)
